(19) United States
(12) Patent Application Publication
(10) Pub. No.: US 2025/0279571 A1
(43) Pub. Date: Sep. 4, 2025

(54) WINDOW GLASS FOR VEHICLE

(71) Applicant: AGC Inc., Tokyo (JP)

(72) Inventors: Satoshi KANEKO, Tokyo (JP); Hideaki Shoji, Tokyo (JP); Shoichi Takeuchi, Tokyo (JP)

(73) Assignee: AGC Inc., Tokyo (JP)

(21) Appl. No.: 19/210,084

(22) Filed: May 16, 2025

Related U.S. Application Data
(63) Continuation of application No. PCT/JP2023/040907, filed on Nov. 14, 2023.

(30) Foreign Application Priority Data
Nov. 22, 2022 (JP) 2022-186874

(51) Int. Cl. H01Q 1/12; B32B 17/10; H05B 3/86

(52) U.S. Cl. CPC H01Q 1/1278; B32B 17/10036; B32B 17/10385; B32B 17/10495; H05B 3/86; B32B 2307/202; B32B 2605/00; H05B 2203/013

(57) ABSTRACT

A window glass for a vehicle comprises a laminated glass for a vehicle including a first glass plate having a first main surface and a second main surface opposite to the first main surface, a second glass plate having a third main surface facing the second main surface and a fourth main surface opposite to the third main surface, and an interlayer film disposed between the second main surface and the third main surface, a planar antenna disposed between the second main surface and the third main surface, and a conductive member that is separated from the antenna in a direction from the first glass plate toward the second glass plate and overlaps at least a part of the antenna in a plan view of the laminated glass.

### INCORPORATION BY REFERENCE

This application is based upon and claims the benefit of priority from Japanese patent application No. 2022-186874, filed on Nov. 22, 2022, and PCT application No. PCT/JP2023/040907 filed on Nov. 14, 2023, the disclosure of which is incorporated herein in its entirety by reference.

### BACKGROUND

Conventionally, there is known a window glass for a vehicle including a conductive member that heats a glass plate by applying a voltage to a pair of bus bars for anti-fogging and anti-icing and an antenna provided in the vicinity of a heating region where the conductive member is disposed (see, for example, International Patent Publication No. WO 2016/185898 and International Patent Publication No. WO 2016/096432).

### SUMMARY

However, in a window glass in which an antenna is provided in a non-conductive region extending around a conductive region where a conductive member for anti-fogging or the like is disposed, if the degree of freedom of the shape and arrangement of the antenna is to be secured, an appropriate conductive region may not be secured. Conversely, when an attempt is made to secure a sufficient conductive region, the region where the antenna is disposed may be limited. As described above, there may be a trade-off relationship between the arrangement of the antenna and the arrangement of the conductive member.

The present disclosure provides a window glass for a vehicle in which it is easy to secure a region where an antenna and a conductive member are disposed.

The present disclosure provides a window glass for a vehicle including
a laminated glass for a vehicle including a first glass plate having a first main surface and a second main surface opposite to the first main surface, a second glass plate having a third main surface facing the second main surface and a fourth main surface opposite to the third main surface, and an interlayer film disposed between the second main surface and the third main surface,
a planar antenna disposed between the second main surface and the third main surface, and
a conductive member that is separated from the antenna in a direction from the first glass plate toward the second glass plate and overlaps at least a part of the antenna in a plan view of the laminated glass.

According to the present disclosure, it is possible to provide a window glass for a vehicle in which it is easy to secure a region where an antenna and a conductive member are disposed.

The above and other objects, features and advantages of the present disclosure will become more fully understood from the detailed description given hereinbelow and the accompanying drawings.

### BRIEF DESCRIPTION OF THE DRAWINGS

FIG. 1 is a cross-sectional view of an upper side portion of a window glass for a vehicle in a first embodiment;

FIG. 2 is a cross-sectional view of an upper side portion of a window glass for a vehicle in a second embodiment;

FIG. 3 is a cross-sectional view of an upper side portion of a window glass for a vehicle in a third embodiment;

FIG. 4 is a cross-sectional view of an upper side portion of a window glass for a vehicle in a fourth embodiment;

FIG. 5 is a cross-sectional view of an upper side portion of a window glass for a vehicle in a fifth embodiment;

FIG. 6 is a cross-sectional view of an upper side portion of a window glass for a vehicle in a sixth embodiment;

FIG. 7 is a cross-sectional view of an upper side portion of a window glass for a vehicle in a seventh embodiment;

FIG. 8 is a cross-sectional view of an upper side portion of a window glass for a vehicle in an eighth embodiment;

FIG. 9 is a cross-sectional view of an upper side portion of a window glass for a vehicle in a ninth embodiment;

FIG. 10 is a plan view illustrating a specific example of a window glass for a vehicle according to the present embodiment;

FIG. 11 is a plan view illustrating a specific example of a planar antenna according to the present embodiment; and

FIG. 12 is a diagram illustrating an example of a measurement result of frequency characteristics of an antenna.

### DESCRIPTION OF EMBODIMENTS

Hereinafter, embodiments will be described with reference to the drawings. For easy understanding, the scale of each part in the drawings may be different from the actual scale. In directions such as parallel, right angle, orthogonal, horizontal, vertical, up and down, and left and right, and terms such as the same and equal, deviations are allowed to an extent that do not impair functions and effects of the embodiments. The shape of the corner portions is not limited to a right angle, and may be rounded in an arch shape. The term “facing” is not limited to a form in which all of them face each other, and may include a form in which some of them face each other. The “overlapping” is not limited to a form in which all of them overlap, and may include a form in which some of them overlap.

The X-axis direction, the Y-axis direction, and the Z-axis direction represent a direction parallel to the X-axis, a direction parallel to the Y-axis, and a direction parallel to the Z-axis, respectively. The X-axis direction, the Y-axis direction, and the Z-axis direction are orthogonal to each other. The XY plane, the YZ plane, and the ZX plane represent a virtual plane parallel to the X-axis direction and the Y-axis direction, a virtual plane parallel to the Y-axis direction and the Z-axis direction, and a virtual plane parallel to the Z-axis direction and the X-axis direction, respectively. In the present embodiment, the X-axis direction is parallel to the left-right direction (lateral direction) of the vehicle body, the vehicle width direction of the vehicle body, or the horizontal direction (direction parallel to the horizontal plane).

As an example of the window glass for a vehicle in the present embodiment, a windshield attached to a front portion of a vehicle is preferable. However, the window glass for a vehicle is not limited to the windshield, and may be, for example, a rear glass attached to a rear portion of the vehicle, a side glass attached to a side portion of the vehicle, a roof glass attached to a ceiling portion of the vehicle, or the like. The window glass for a vehicle may be a window glass in which a roof glass is integrated with one or both of a windshield and a rear glass.

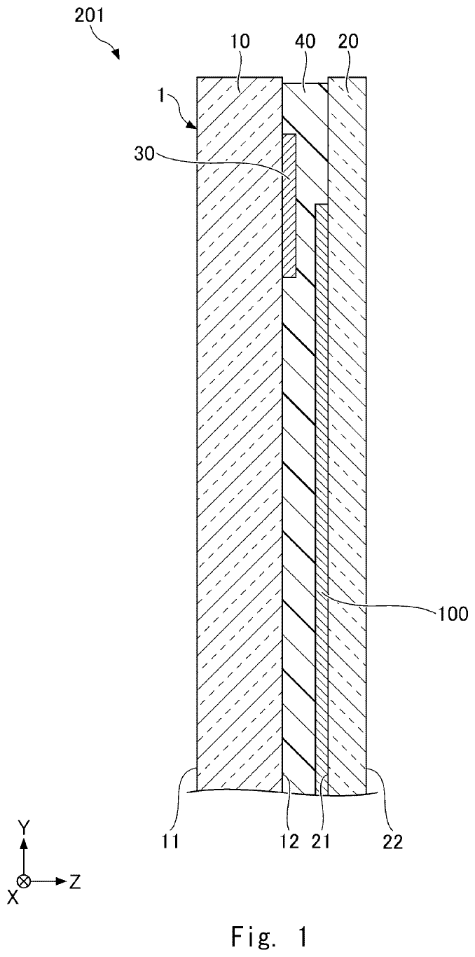

FIG. 1 is a cross-sectional view of an upper side portion when a window glass for a vehicle (windshield) is attached to a vehicle in a first embodiment. The positive side in the Z-axis direction corresponds to the vehicle inner side, and the negative side in the Z-axis direction corresponds to the vehicle outer side. A window glass for a vehicle 201 includes a glass plate 1, an antenna 30, and a conductive member 100.

The glass plate 1 is an example of a laminated glass for vehicles. The glass plate 1 includes a glass plate 10, a glass plate 20, and an interlayer film 40. In the example illustrated in FIG. 1, the glass plate 1 is a laminated glass in which the glass plate 10 disposed on the vehicle outer side and the glass plate 20 disposed on the vehicle inner side are bonded to each other via the interlayer film 40. The interlayer film 40 is sandwiched between the glass plate 10 and the glass plate 20.

The glass plate 10 and the glass plate 20 are transparent dielectric plates. One or both of the glass plate 10 and the glass plate 20 may be translucent. The glass plate 10 is an example of a first glass plate, and the glass plate 20 is an example of a second glass plate.

The glass plate 10 has a main surface 11 facing a negative side in the Z-axis direction and a main surface 12 facing an opposite side (positive side in the Z-axis direction) to the main surface 11 in the Z-axis direction. The main surface 11 represents a surface on the vehicle outer side, and the main surface 12 represents a surface on the vehicle inner side. In particular, the main surface 11 corresponds to a surface of the laminated glass on the vehicle outer side. The main surface 11 is an example of a first main surface. The main surface 12 is an example of a second main surface.

The glass plate 20 is a dielectric plate facing the glass plate 10. The glass plate 20 is disposed on the main surface 12 side with respect to the glass plate 10. The glass plate 10 has a main surface 21 facing the main surface 12 of glass plate 10, and a main surface 22 facing a side opposite to the main surface 21 in the Z-axis direction. The main surface 21 represents a surface on the vehicle outer side, and the main surface 22 represents a surface on the vehicle inner side. In particular, the main surface 22 corresponds to a surface of the laminated glass on the vehicle inner side. The main surface 21 is an example of a third main surface. The main surface 22 is an example of a fourth main surface.

In the case of the laminated glass, the thickness of the glass plate 10 is not particularly limited, but can be appropriately selected in the range of 0.1 mm to 10 mm. The thickness of the glass plate 10 is preferably 0.3 mm or more, more preferably 0.5 mm or more, still more preferably 0.7 mm or more, particularly preferably 1.1 mm or more, and most preferably 1.6 mm or more. In addition, the thickness of the glass plate 10 is preferably 3.0 mm or less, more preferably 2.6 mm or less, and still more preferably 2.1 mm or less so that the mass of the laminated glass does not become too large. The thickness of the glass plate 10 may be the same as or different from the thickness of the glass plate 20. As long as the glass plate 10 and the glass plate 20 have the same thickness, glass plates having the same size can be used.

The interlayer film 40 is a film having dielectric properties and disposed between the main surface 12 of the glass plate 10 and the main surface 21 of the glass plate 20. The interlayer film 40 is a transparent or translucent dielectric interposed between the glass plate 10 and the glass plate 20. The glass plate 10 and the glass plate 20 are bonded by the interlayer film 40. Examples of the interlayer film 40 include thermoplastic polyvinyl butyral (PVB), an ethylene vinyl acetate copolymer (EVA), and a cycloolefin polymer (COP). The relative permittivity of the interlayer film 40 is preferably 2.4 or more and 3.5 or less.

The antenna 30 is a planar antenna disposed between the main surface 12 and the main surface 21. The antenna 30 may be a grid-like planar antenna in which at least one hole is formed in a planar conductor, a mesh-like planar antenna in which holes are finer and conductors are thinner, or a solid planar antenna in which holes are not formed in a planar conductor.

The antenna 30 is formed to be able to transmit and receive a radio wave in a predetermined frequency band (at least one of transmission and reception). The radio wave in the predetermined frequency band may be a vertically polarized wave, a horizontally polarized wave, or a circularly polarized wave. The predetermined frequency band is a relatively high frequency band (600 MHz to 3 GHZ) in an ultra high frequency (UHF) band, a super high frequency (SHF) band of 3 GHz to 30 GHz, or an extremely high frequency (EHF) band of 30 GHz to 300 GHz. As a specific example of such a high frequency band, there is a band (frequency band of 6 GHz or less (sub6) and frequency band of 24 GHz or more (28 GHz band, 39 GHz band, and the like)) used in the fifth generation communication (5G) standard.

The antenna 30 may be impedance matched to efficiently transmit and receive a radio wave of Wi-Fi, which is a wireless local area network (LAN). The antenna 30 may be impedance matched to transmit and receive radio waves in a frequency band (863 MHz to 868 MHz (Europe), 902 MHz to 928 MHz (USA), 2400 MHz to 2497 MHz (universal), 5150 MHz to 5350 MHZ (universal), 5470 MHz to 5850 MHz (universal), and the like) defined by the communication standards IEEE 802.11a, b, g, n, ac, ah, and ax.

The antenna 30 may be impedance matched to transmit and receive radio waves having a frequency of 2400 MHZ to 2483.5 MHz used in Bluetooth (registered trademark). The antenna 30 may be impedance matched to transmit and receive radio waves in a frequency band (755.5 MHz to 764.5 MHZ (Japan) defined by ARIB STD-T109, 5850 MHz to 5925 MHz defined by IEEE802.11p, and the like) used in vehicle-to-infrastructure (V2I) or vehicle-to-vehicle (V2V) communication in intelligent transport systems (ITS). The antenna 30 may be impedance matched to transmit and receive radio waves in a frequency band (2300 MHz to 2400 MHZ, 2496 MHz to 2690 MHz, 3400 MHz to 3600 MHZ, and the like) used in WiMAX (registered trademark) which is another wireless communication technology. The antenna 30 may be impedance matched to transmit and receive a radio wave in a low band (3245 MHz to 4742 MHZ) of an ultra wideband (UWB) wireless communication system.

The conductive member 100 is separated from the antenna 30 in a direction from the glass plate 10 toward the glass plate 20 (in this example, the positive Z-axis direction). The conductive member 100 is, for example, a member capable of generating heat for antifogging and the like. The conductive member 100 may have a function other than heat generation as long as it is a member having conductivity.

The conductive member 100 overlaps at least a part of the antenna 30 in a plan view of the glass plate 1 in the positive Z-axis direction. Since the conductive member 100 overlaps at least a part of the antenna 30 in a plan view of the glass plate 1, it is easy to secure a region where the antenna 30 and the conductive member 100 are disposed as compared with a form in which the conductive member 100 does not overlap the antenna 30 in a plan view of the glass plate 1. For example, even if the size required for the antenna 30 is secured, the region where the conductive member 100 is disposed can be sufficiently secured, and conversely, even if the size required for the antenna is secured in the region where the conductive member 100 is disposed, the size required for the antenna 30 can be sufficiently secured.

In addition, since the conductive member 100 overlaps at least a part of the antenna 30 in a plan view of the glass plate 1, the antenna 30 can use the conductive member 100 as a reflector that reflects radio waves, and thus the antenna gain (directivity) on the opposite side (in this example, the negative side in the Z-axis direction) to the side where the conductive member 100 is positioned with respect to the antenna 30 is improved.

The conductive member 100 may be a planar conductive film or a member including a plurality of heating wires 26 to be described later. Thus, the antenna can use the conductive member 100 as a reflector that reflects radio waves.

In a case where the conductive member 100 is a planar conductive film, when the sheet resistance of the conductive member (conductive film) is 5 [Ω/□] or more, in the antenna 30, the conductive member 100 can be used as a reflecting member that reflects a radio wave in a frequency band transmitted and received by the antenna 30, and the antenna gain (directivity) on the negative side in the Z-axis direction is improved. The sheet resistance is preferably 7 [Ω/□] or more, more preferably 10 [Ω/□] or more from the viewpoint of improving the antenna gain (directivity) on the negative side in the Z-axis direction. The upper limit value of the sheet resistance is not particularly limited, but may be 30 [Ω/□] or less.

In the example illustrated in FIG. 1, the antenna 30 is disposed between the main surface 12 and the interlayer film 40. The antenna 30 may be in contact with the main surface 12, but a dielectric layer (not illustrated) such as a light shielding layer that shields visible light may be interposed between the antenna 30 and the main surface 12. The light shielding layer (not illustrated) is, for example, an opaque colored ceramic layer, and the color is arbitrary, but dark color such as black, brown, gray, and deep blue or white is preferable, and black is more preferable.

In the example illustrated in FIG. 1, the conductive member 100 is disposed between the interlayer film 40 and the main surface 21. The conductive member 100 may be in contact with the main surface 21, but a dielectric layer (not illustrated) such as a light shielding layer that shields visible light may be interposed between the conductive member 100 and the main surface 21. Furthermore, a light shielding layer (not illustrated) may be disposed on the main surface 22.

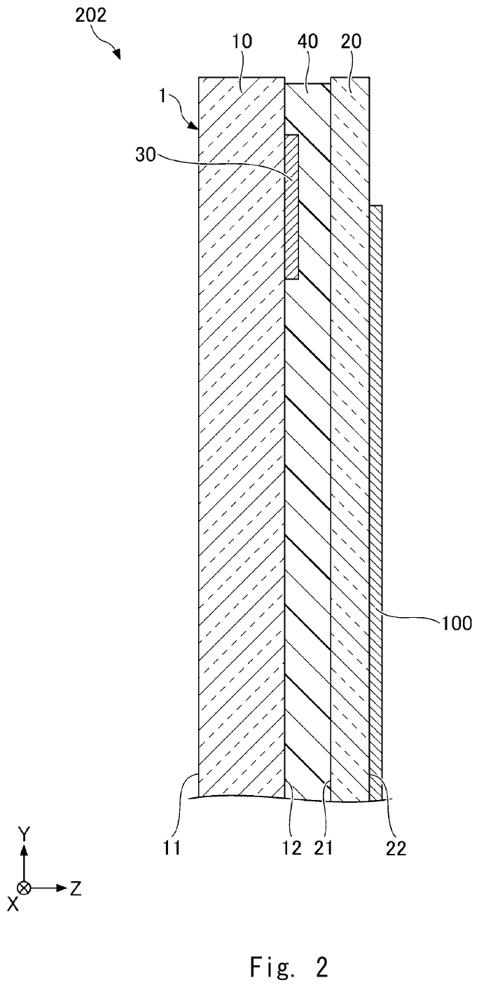

FIG. 2 is a cross-sectional view of an upper side portion of a window glass for a vehicle in a second embodiment. In the second embodiment, the description of the same configuration, operation, and effect as those of the first embodiment will be omitted or simplified by incorporating the above description. A window glass for a vehicle 202 illustrated in FIG. 2 is different from the window glass for a vehicle 201 in the first embodiment in that the conductive member 100 is disposed on the main surface 22. In the case of the second embodiment, since the conductive member 100 overlaps at least a part of the antenna 30 in a plan view of the glass plate 1, it is easy to secure a region where the antenna 30 and the conductive member 100 are disposed.

In FIG. 2, the conductive member 100 may be in contact with the main surface 22, but a dielectric layer (not illustrated) such as a light shielding layer that shields visible light may be interposed between the conductive member 100 and the main surface 22. In a case where the conductive member 100 is disposed on the main surface 22, the vehicle inner side which is the surface (the negative side in the Z-axis direction) thereof is preferably overcoated with a dielectric layer. In addition, the dielectric layer coating the conductive member 100 is preferably transparent in visible light.

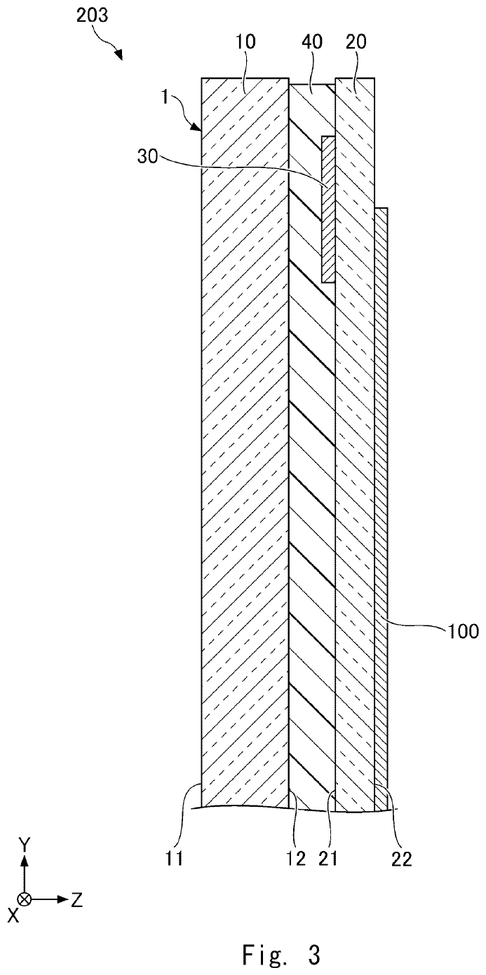

FIG. 3 is a cross-sectional view of an upper side portion of a window glass for a vehicle in a third embodiment. In the third embodiment, the description of the same configuration, operation, and effect as those of the above-described embodiment will be omitted or simplified by incorporating the above description. A window glass for a vehicle 203 illustrated in FIG. 3 is different from the window glass for a vehicle 202 in the second embodiment in that the antenna 30 is disposed on the main surface 21. In the case of the third embodiment, since the conductive member 100 overlaps at least a part of the antenna 30 in a plan view of the glass plate 1, it is easy to secure a region where the antenna 30 and the conductive member 100 are disposed.

In FIG. 3, the antenna 30 may be in contact with the main surface 21, but a dielectric layer (not illustrated) such as a light shielding layer that shields visible light may be interposed between the antenna 30 and the main surface 21. Furthermore, the light shielding layer (not illustrated) may be disposed in a part between the main surface 22 and the conductive member 100.

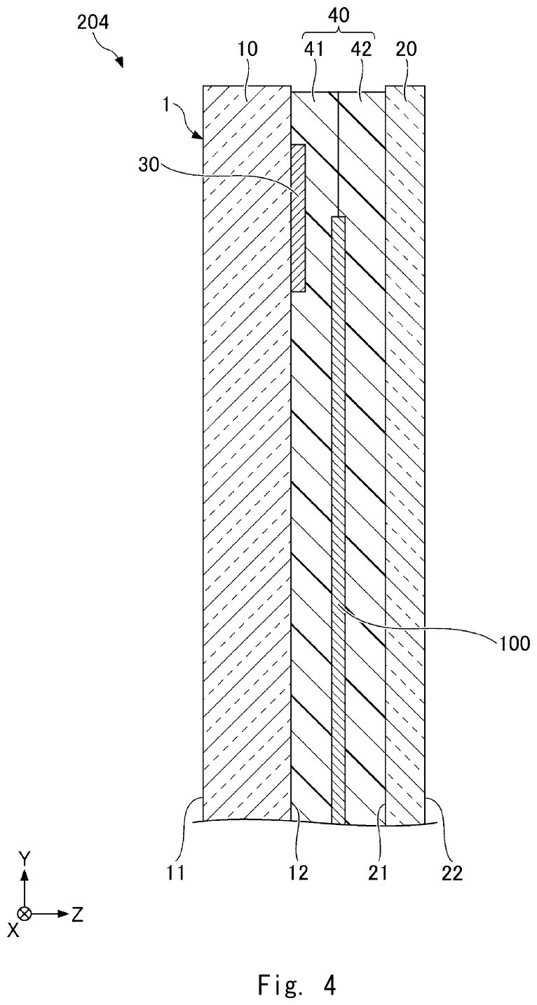

FIG. 4 is a cross-sectional view of an upper side portion of a window glass for a vehicle in a fourth embodiment. In the fourth embodiment, the description of the same configuration, operation, and effect as those of the above-described embodiment will be omitted or simplified by incorporating the above description. A window glass for a vehicle 204 illustrated in FIG. 4 is different from the window glass for a vehicle 201 in the first embodiment in that the interlayer film 40 includes an interlayer film 41 and an interlayer film 42 sandwiching the conductive member 100 in a thickness direction (in this example, the Z-axis direction) of the glass plate 1. In the case of the fourth embodiment, since the conductive member 100 overlaps at least a part of the antenna 30 in a plan view of the glass plate 1, it is easy to secure a region where the antenna 30 and the conductive member 100 are disposed.

As the description of the interlayer film 41 and the interlayer film 42, the above description of the interlayer film 40 is incorporated. The interlayer film 41 is an example of a first interlayer film. The interlayer film 42 is an example of a second interlayer film. In this example, the conductive member 100 is sandwiched between the interlayer film 41 in contact with the main surface 12 and the interlayer film 42 in contact with the main surface 21. A dielectric layer (not illustrated) such as a light shielding layer that shields visible light may be interposed between the interlayer film 41 and the main surface 12, or may be interposed between the interlayer film 42 and the main surface 21.

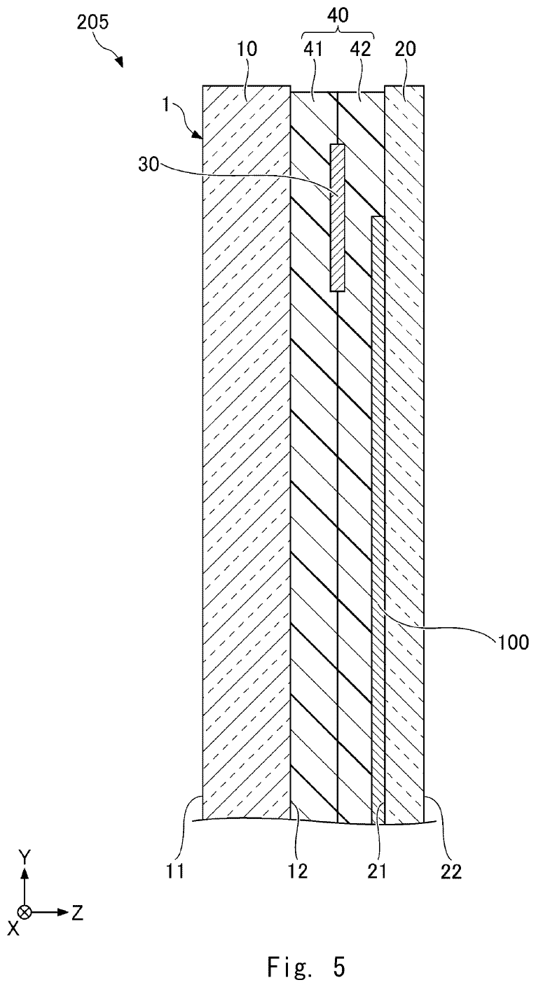

FIG. 5 is a cross-sectional view of an upper side portion of a window glass for a vehicle in a fifth embodiment. In the fifth embodiment, the description of the same configuration, operation, and effect as those of the above-described embodiment will be omitted or simplified by incorporating the above description. A window glass for a vehicle 205 illustrated in FIG. 5 is different from the window glass for a vehicle 201 in the first embodiment in that the interlayer film 40 includes an interlayer film 41 and an interlayer film 42 sandwiching the antenna 30 in a thickness direction (in this example, the Z-axis direction) of the glass plate 1. In the case of the fifth embodiment, since the conductive member 100 overlaps at least a part of the antenna 30 in a plan view of the glass plate 1, it is easy to secure a region where the antenna 30 and the conductive member 100 are disposed.

The interlayer film 42 is disposed between the interlayer film 41 and the main surface 21. The conductive member 100 is disposed between the interlayer film 42 and the main surface 21.

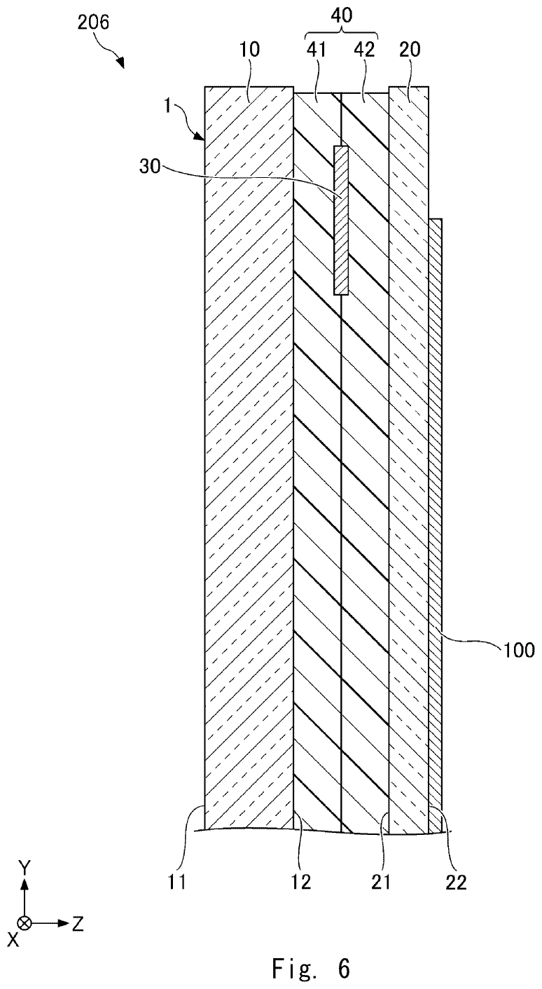

FIG. 6 is a cross-sectional view of an upper side portion of a window glass for a vehicle in a sixth embodiment. In the sixth embodiment, the description of the same configuration, operation, and effect as those of the above-described embodiment will be omitted or simplified by incorporating the above description. A window glass for a vehicle 206 illustrated in FIG. 6 is different from the window glass for a vehicle 205 in the fifth embodiment in that the conductive member 100 is disposed on the main surface 22. In the case of the sixth embodiment, since the conductive member 100 overlaps at least a part of the antenna 30 in a plan view of the glass plate 1, it is easy to secure a region where the antenna 30 and the conductive member 100 are disposed.

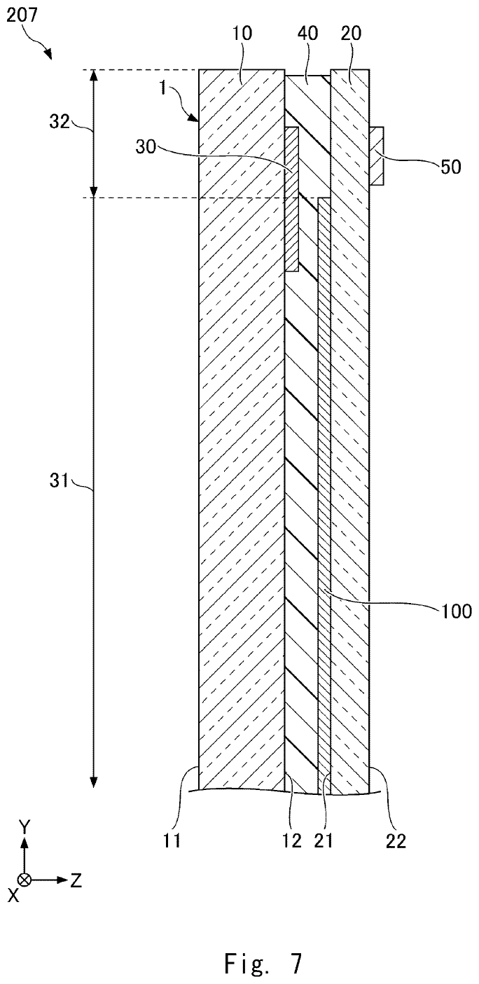

FIG. 7 is a cross-sectional view of an upper side portion of a window glass for a vehicle in a seventh embodiment. In the seventh embodiment, the description of the same configuration, operation, and effect as those of the above-described embodiment will be omitted or simplified by incorporating the above description. A window glass for a vehicle 207 illustrated in FIG. 7 is different from the window glass for a vehicle 201 in the first embodiment in that an electrode 50 provided on the main surface 22 is provided. The configuration described in the seventh embodiment may be applied to any of the plurality of embodiments described above.

The electrode 50 is connected to a transmission line (not illustrated) and is connected to a communication device (not illustrated) via the transmission line. Specific examples of the transmission line include a microstrip line, a strip line, a coplanar waveguide, a GCPW (coplanar waveguide with ground plane), a coplanar strip, a slot line, a waveguide, and the like. The transmission line may be a coaxial cable.

The electrode 50 is electrically connected to the antenna 30, and in this example, is connected to the antenna 30 by capacitive coupling or electromagnetic coupling. The electrode 50 is capacitively coupled or electromagnetically coupled to the antenna 30 at an interval thinner than the thickness of the glass plate 10 in the Z-axis direction, for example. Since the electrode 50 and the antenna 30 are close to each other at a distance that can be capacitively coupled or electromagnetically coupled, the electrode 50 feeds signal to the antenna 30 sealed in the pair of glass plates 10 and 20 in a non-contact manner by capacitive coupling or electromagnetic coupling. By contactless feeding by capacitive coupling or electromagnetic coupling, even if the glass plate 20 and the interlayer film 40 are interposed between the antenna 30 and the electrode 50, a simple feeding structure capable of feeding signal to the antenna 30 between the pair of glass plates 10 and can be realized. In addition, according to this feeding structure, even if the positive side end portion of the antenna 30 in the Y-axis direction is on the inner side (the negative side in the Y-axis direction) of the positive side end portion of the interlayer film 40 in the Y-axis direction, signal can be fed from the electrode 50 to the antenna 30 in the Z-axis direction with a simple structure.

In a plan view of the glass plate 1 in the positive Z-axis direction, a region where the conductive member 100 is disposed is referred to as a first region 31, and a region positioned outside the first region 31 is referred to as a second region 32. The electrode 50 is positioned in the second region 32 and faces the antenna 30 with the glass plate 20 interposed therebetween. With this arrangement, the electrode 50 can be connected to the antenna 30 by capacitive coupling or electromagnetic coupling even when the conductive member 100 is present. Note that, in FIG. 7, the electrode 50 is illustrated as one electrode (in the drawings, a single electrode) for convenience, but a plurality of electrodes 50 (so-called bipolar) may be provided. That is, in a case where the electrode 50 is provided in a plurality of locations (for example, two), an electrode for a signal to be fed to the antenna and a ground electrode corresponding to the ground potential may be provided. In this case, when the transmission line (not illustrated) is a coaxial cable, a core wire of the coaxial cable is connected to the signal electrode of the electrode 50, and a sheath wire is connected to the ground electrode.

The form in which the electrode 50 is provided on the main surface 22 may be a form in which the electrode 50 is provided on the bottom surface of the recess formed on the main surface 22, a form in which a dielectric layer is interposed between the electrode 50 and the main surface 22, a form in which a terminal provided with the electrode 50 is fitted into a hole formed in the main surface 22, or the like. The hole formed in the main surface 22 may or may not penetrate from the main surface 22 to the main surface 21.

The distance at which the antenna 30 and the electrode 50 can be electromagnetically coupled is, for example, 500 μm or less, preferably 250 μm or less, more preferably 150 μm or less, still more preferably 100 μm or less, and most preferably 50 μm or less.

The thickness of the glass plate 10 may be the same as the thickness of the glass plate 20, or may be thicker than the glass plate 20, for example. In a case where the thickness of the glass plate 10 is larger than the thickness of the glass plate 20, the thickness of the glass plate 10 may be, for example, about 3.2 mm. In addition, the composition of the glass plate 20 can be appropriately selected, but a tempered glass is preferable as the glass plate capable of obtaining a predetermined strength with an electromagnetically couplable thickness as described above. Examples of the tempered glass include air-cooled tempered glass and chemically tempered glass, and as the tempered glass having a thin plate thickness, chemically tempered glass is preferable. In a case where the glass plate is chemically strengthened glass, the glass plate 20 may have a composition that can be strengthened by molding and chemical strengthening treatment. Examples of the glass plate that can be chemically strengthened include aluminosilicate glass, soda lime glass, borosilicate glass, lead glass, alkali barium glass, and aluminoborosilicate glass.

The feeding structure including the electrode 50 is suitable for feeding signal to the antenna 30 through which a high-frequency signal having a frequency in a relatively high band passes when signal is fed by contactless feeding by capacitive coupling or electromagnetic coupling. In addition, in order to reduce the loss of the high frequency signal, the dielectric loss tangent (tan δ) of the glass plate 20 is preferably low. For example, tan δ of the glass plate 20 at a frequency of 10 GHz is preferably 0.010 or less, and more preferably 0.009 or less.

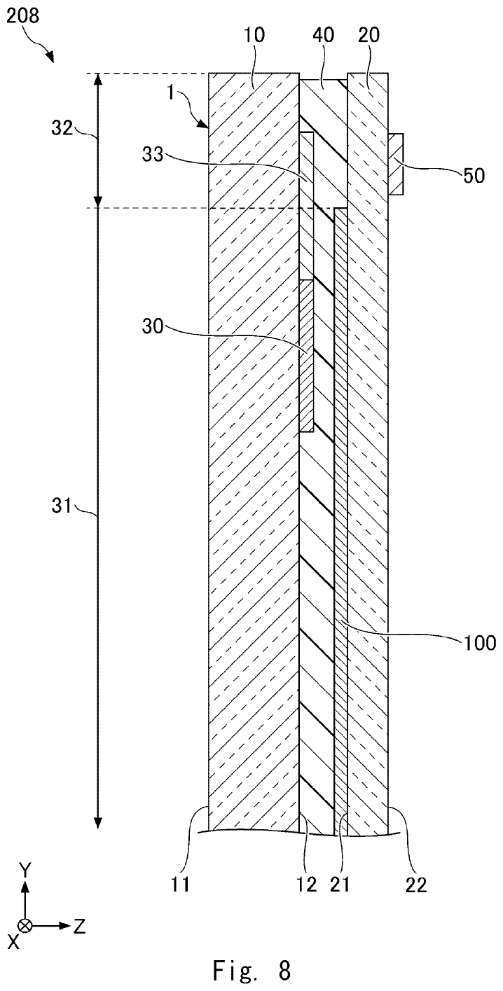

FIG. 8 is a cross-sectional view of an upper side portion of a window glass for a vehicle in an eighth embodiment. In the eighth embodiment, the description of the same configuration, operation, and effect as those of the above-described embodiment will be omitted or simplified by incorporating the above description. A window glass for a vehicle 208 illustrated in FIG. 8 is different from the window glass for a vehicle 207 in the seventh embodiment in that a line 33 connected to the antenna 30 at the same layer is provided. The configuration described in the eighth embodiment may be applied to any of the plurality of embodiments described above.

The electrode 50 is electrically connected to the antenna 30, and in this example, is connected to the line 33 connected in the same layer as the antenna 30 by capacitive coupling or electromagnetic coupling, and is electrically connected to the antenna 30 via the line 33. The line 33 may include, for example, a transmission line as exemplified above. Specific examples of the line 33 include a flexible substrate on which a transmission line is formed. Since the electrode 50 and the line 33 are close to each other at a distance capable of being capacitively coupled or electromagnetically coupled, the electrode 50 feeds signal to the line 33 sealed in the pair of glass plates 10 and 20 in a non-contact manner by capacitive coupling or electromagnetic coupling, and can feed signal to the antenna 30 via the line 33.

The electrode 50 is positioned in the second region 32 and faces the line 33 connected to the antenna 30 in the same layer with the glass plate 20 interposed therebetween. With this arrangement, the electrode 50 can be connected to the line 33 by capacitive coupling or electromagnetic coupling even when the conductive member 100 is present. In addition, since the line 33 is interposed, even if the entire antenna 30 overlaps the conductive member 100 in a plan view of the glass plate 1 (even if the antenna is included in the first region 31), the electrode 50 can feed signal to the antenna 30 via the line 33.

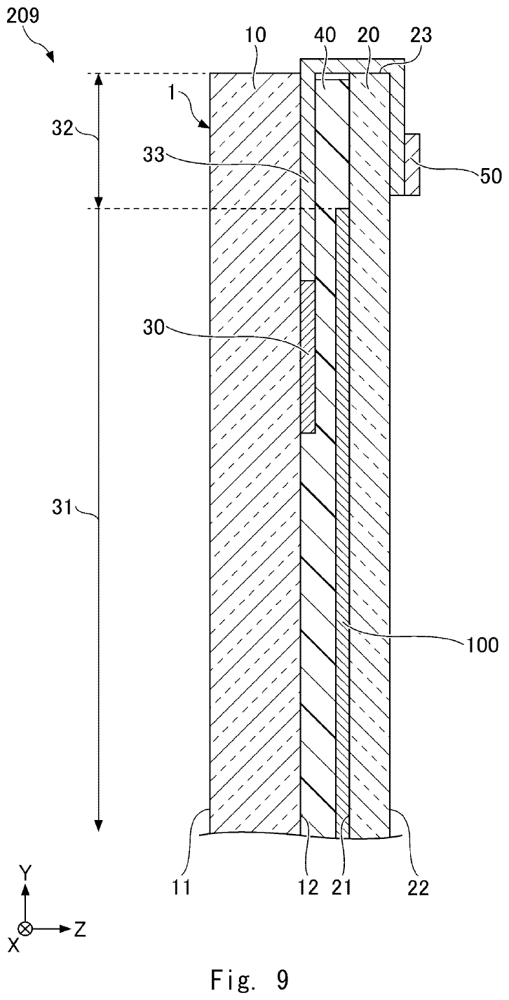

FIG. 9 is a cross-sectional view of an upper side portion of a window glass for a vehicle in a ninth embodiment. In the ninth embodiment, the description of the same configuration, operation, and effect as those of the above-described embodiment will be omitted or simplified by incorporating the above description. A window glass for a vehicle 209 illustrated in FIG. 9 is different from the window glass for a vehicle 208 in the eighth embodiment in that an electrode 50 is connected to an antenna 30 via a line 33 passing through the outside of an end surface 23 of a glass plate 20. The configuration described in the ninth embodiment may be applied to any of the plurality of embodiments described above.

The electrode 50 is electrically connected to the antenna 30, and in this example, is electrically connected to the antenna 30 via the line 33 passing through the outside of the end surface 23 of the glass plate 20. The line 33 may include, for example, a transmission line as exemplified above. Specific examples of the line 33 include a flat harness in which a transmission line is formed. The electrode 50 can feed signal to the antenna 30 via the line 33. In FIG. 9, the electrode 50 is positioned in the second region 32, but may be positioned in the first region 31 or may be positioned across the first region 31 and the second region 32.

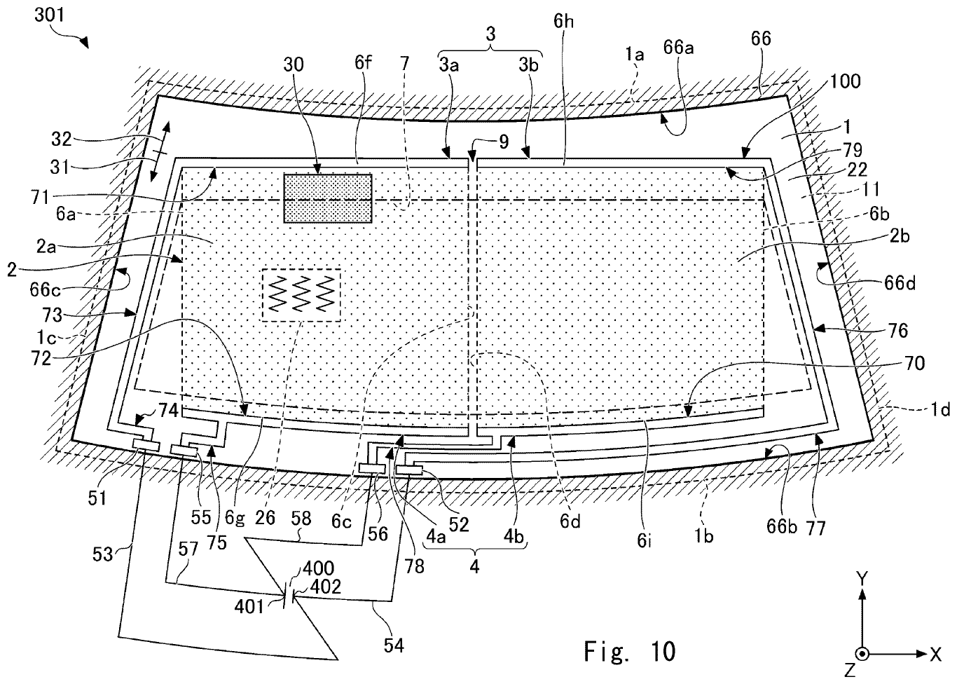

FIG. 10 is a plan view illustrating a specific example of a window glass for a vehicle according to the present embodiment. The plurality of cross-sectional structures described above may be applied to the configuration illustrated in FIG. 10. FIG. 10 illustrates a window glass for a vehicle 301 attached to a window frame 66 of the vehicle body as viewed from inside the vehicle. The window glass for a vehicle 301 is, for example, a windshield attached to the window frame 66 formed at the front portion of the vehicle body.

The window frame 66 has an upper frame 66a, a lower frame 66b, a left frame 66c, and a right frame 66d to form an opening covered by the window glass for a vehicle 301. The upper frame 66a is a window frame portion extending in the X-axis direction on the positive side in the Y-axis direction of the vehicle body, and is, for example, a flange on the ceiling side of the vehicle body. The lower frame 66b is a window frame portion extending in the X-axis direction on the negative side in the Y-axis direction of the vehicle body, and is, for example, a flange on the dash panel side of the vehicle body. The left frame 66c is a window frame portion connecting the upper frame 66a and the lower frame 66b on the negative side in the X-axis direction of the vehicle body, and is, for example, an A-pillar flange on the front left side of the vehicle body. The right frame 66d is a window frame portion connecting the upper frame 66a and the lower frame 66b on the positive side in the X-axis direction of the vehicle body, and is, for example, an A-pillar flange on the front right side of the vehicle body.

The window glass for a vehicle 301 includes the glass plate 1, the antenna 30, and the conductive member 100. In this example, the conductive member 100 includes a first bus bar 3, a second bus bar 4, and a heating element 2. In FIG. 10, the antenna 30 is disposed in a first heating region 2a to be described later, but is not limited thereto, and may be disposed in a second heating region 2b to be described later. Furthermore, the number of antennas 30 is not limited to one, and a plurality of antennas may be provided. In this case, the antennas may be disposed in any one of the first heating region 2a and the second heating region 2b, and one or more antennas may be disposed in each region.

The glass plate 1 is an example of a laminated glass for vehicles. The glass plate 1 is a transparent or translucent dielectric plate attached to the window frame 66. The glass plate 1 has an outer peripheral edge including an upper edge 1a, a lower edge 1b, a left edge 1c, and a right edge 1d. The upper edge 1a is a glass edge extending in the X-axis direction on the positive side in the Y-axis direction of the vehicle body, and is attached to the upper frame 66a. The lower edge 1b is a glass edge extending in the X-axis direction on the negative side in the Y-axis direction of the vehicle body, and is attached to the lower frame 66b. The left edge 1c is a glass edge connecting the upper edge 1a and the lower edge 1b on the negative side in the X-axis direction of the vehicle body, and is attached to the left frame 66c. The right edge 1d is a glass edge connecting the upper edge 1a and the lower edge 1b on the positive side in the X-axis direction of the vehicle body, and is attached to the right frame 66d.

The glass plate 1 has the main surface 22 and the main surface 11 opposite to the main surface 22. In this example, the main surface 22 is a surface on the vehicle inner side, and the main surface 11 is a surface on the vehicle outer side.

The first bus bar 3 is a strip-shaped electrode provided on the glass plate 1. The first bus bar 3 includes upper portions 71 and 79 extending in a direction (for example, in a substantially horizontal direction,) along the upper edge 1a of the glass plate 1. The first bus bar 3 is conductively connected to one electrode terminal (for example, the negative electrode terminal 402) of a power source 400 mounted on the vehicle.

The second bus bar 4 is a strip-shaped electrode provided on the glass plate 1 and spaced apart from the first bus bar 3 on the negative side in the Y-axis direction. The second bus bar 4 includes lower portions 72 and 70 extending in a direction (for example, in a substantially horizontal direction) along the lower edge 1b of the glass plate 1. The second bus bar 4 is conductively connected to the other electrode terminal (for example, a positive electrode terminal 401) of the power source 400 mounted on the vehicle.

The first bus bar 3 may be conductively connected to a positive electrode terminal 401 of the power source 400, and the second bus bar 4 may be conductively connected to the negative electrode terminal 402 of the power source 400.

The heating element 2 is connected between the first bus bar 3 and the second bus bar 4. The heating element 2 forms a heating region extending between the upper portions 71 and 79 and the lower portions 72 and 70. The heating region is a region where the heating element 2 is disposed, and is heated by heat generated by the heating element 2. The heating region has a pair of lateral sides (left side 6a and right side 6b) facing each other in the X-axis direction.

The heating element 2 is provided on the glass plate 1 and is positioned between the upper portions 71 and 79 and the lower portions 72 and 70. The heating element 2 is a member through which a direct electrical current flows in the vertical direction between the upper portions 71 and 79 and the lower portions 72 and 70 when the direct voltage is applied between the first bus bar 3 and the second bus bar 4 by the power source 400, and generates heat when the direct electrical current flows in the vertical direction. The heating region where the heating element 2 is disposed is heated by heat generated by the heating element 2 that conductively connects the upper portions 71 and 79 and the lower portions 72 and 70. By heating the heating region, melting of snow, melting of ice, anti-fogging, and the like in the heating region and a region in the vicinity of the heating region in the glass plate 1 can be performed.

The heating element 2 is disposed on the same layer (inner layer or main surface 22) as the first bus bar 3 and the second bus bar 4. However, the heating element 2 may be disposed in a layer different from at least one of the first bus bar 3 and the second bus bar 4 as long as electrical connection with the first bus bar 3 and the second bus bar 4 is secured via the auxiliary member.

The heating region where the heating element 2 is disposed may be separated into a plurality of heating regions disposed in the X-axis direction. In this example, the heating region has two regions arranged in the X-axis direction via a gap 9 whose longitudinal direction is the vertical direction of the glass plate 1, that is, the first heating region 2a and the second heating region 2b. The heating region where the heating element 2 is disposed may have three or more regions.

The first heating region 2a has a pair of lateral sides (upper side 6f and lower side 6g) facing each other in the Y-axis direction, and a pair of longitudinal sides (left side 6a and right side 6c) facing each other in the Y-axis direction. The heating element 2 disposed in the first heating region 2a is conductively connected to the upper portion 71 at an upper side 6e, and is conductively connected to the lower portion 72 at the lower side 6g.

The second heating region 2b has a pair of lateral sides (upper side 6h and lower side 6i) facing each other in the Y-axis direction, and a pair of longitudinal sides (left side 6d and right side 6b) facing each other in the Y-axis direction. The heating element 2 disposed in the second heating region 2b is conductively connected to the upper portion 79 at the upper side 6h, and is conductively connected to a lower portion 70 at the lower side 6i.

In this example, since the heating region where the heating element 2 is disposed is divided into the plurality of heating regions, the first bus bar 3 and the second bus bar 4 are also divided. The first bus bar 3 includes a first upper bus bar 3a and a second upper bus bar 3b, and the second bus bar 4 includes a first lower bus bar 4a and a second lower bus bar 4b.

The first bus bar 3 may further include a vertical portion connected to the upper portions 71 and 79. In this example, in the first bus bar 3, the first upper bus bar 3a includes a vertical portion 73 connected to the upper portion 71, and the second upper bus bar 3b includes a vertical portion 76 connected to the upper portion 79. The upper portion 71 is a conductor portion connected to the upper side 6f of the first heating region 2a, and the vertical portion 73 is a conductor portion extending in a direction along the left edge 1c, which is one side edge of the glass plate 1, and is located away from the left side 6a, which is one side edge of the first heating region 2a. The upper portion 79 is a conductor portion connected to the upper side of the second heating region 2b, and the vertical portion 76 is a conductor portion extending in a direction along the right edge 1d, which is the other side edge of the glass plate 1, and is located away from the right side 6b, which is one side edge of the second heating region 2b.

Since the first bus bar 3 includes the vertical portions 73 and 76 respectively connected to the upper portions 71 and 79, a part of the wiring line electrically connecting the upper portions 71 and 79 of the first bus bar 3 to the power source 400 can be provided on the glass plate 1 side instead of the vehicle body side. Thus, the length of the harness wired to the vehicle body side can be reduced.

The first bus bar 3 may further include a lateral portion 74 connected to the vertical portion 73, and may further include a lateral portion 77 connected to the vertical portion 76. The lateral portion 74 is a conductor portion extending in a direction along the lower edge 1b of the glass plate 1 in a region away from the first heating region 2a. The lateral portion 77 is a conductor portion extending in a direction along the lower edge 1b of the glass plate 1 in a region away from the second heating region 2b. Due to the presence of the lateral portion 74 or the lateral portion 77, the length of the harness can be further reduced depending on the position of the terminal of the harness to be wired to the vehicle body side.

In this example, the glass plate 1 includes a plurality of electrodes 51, 52, 55, and 56 to which terminals of a plurality of harnesses electrically connected to the power source 400 are electrically connected.

The electrode 51 is a negative electrode for electrically connecting a terminal of a ground harness 53 electrically connected to the negative electrode terminal 402 to the first upper bus bar 3a. The electrode 51 is electrically connected to the upper portion 71 via the lateral portion 74 and the vertical portion 73.

The electrode 52 is a negative electrode for electrically connecting a terminal of a ground harness 54 electrically connected to the negative electrode terminal 402 to the second upper bus bar 3b. The electrode 52 is electrically connected to the upper portion 79 via the lateral portion 77 and the vertical portion 76.

The electrode 55 is a positive electrode for electrically connecting a terminal of a power supply harness 57 electrically connected to the positive electrode terminal 401 to the first lower bus bar 4a. The first lower bus bar 4a has a connection bus bar 75 connected to a lower portion 72. The electrode 55 is electrically connected to the lower portion 72 via the connection bus bar 75.

The electrode 56 is a positive electrode for electrically connecting a terminal of a power supply harness 58 electrically connected to the positive electrode terminal 401 to the second lower bus bar 4b. The second lower bus bar 4b has a connection bus bar 78 connected to the lower portion 70. The electrode 56 is electrically connected to the lower portion 70 via the connection bus bar 78.

As viewed in an enlarged manner in the drawings, for example, the heating element 2 includes a plurality of heating wires 26 extending in the vertical direction of the glass plate 1 and disposed at intervals in the X-axis direction. The plurality of heating wires 26 are connected between the upper portions 71 and 79 and the lower portions 72 and 70. The plurality of heating wires 26 are, for example, wavy filament conductors extending from the first bus bar 3 toward the second bus bar 4. The heating wire is formed of, for example, copper, aluminum, chromium, molybdenum, nickel, titanium, palladium, indium, tungsten, gold, platinum, silver, or an alloy containing a plurality of these elements.

The wire diameter of the heating wire 26 is, for example, 22 μm or more and 30 μm or less, or 22 μm or more and 25 μm or less. The interval (pitch) between adjacent heating wires 26 may be, for example, 2.0 mm or more and 3.0 mm or less, or 2.4 mm or more and 3.0 mm or less. The resistance of the heating wire 26 is, for example, 180 Ω/m at 20° C. when the wire diameter is 22 μm, and 138 Ω/m at 20° C. when the wire diameter is 25 μm.

An interval (pitch) between adjacent the heating wires 26 can be adjusted according to a frequency at which the antenna 30 performs transmission and reception. That is, in order to efficiently reflect the radio wave having a frequency F transmitted and received by the antenna 30 by the heating wire 26, when a wavelength at a predetermined frequency F is λ, an interval P [mm] between the heating wires 26 adjacent to each other may be λ/25 or less. Note that A corresponds to a wavelength including a wavelength shortening rate of a (dielectric) medium such as glass encapsulating the antenna 30, and when a wavelength in the air at a predetermined frequency F is λ₀ and a wavelength shortening rate of a peripheral medium encapsulating the antenna 30 is k, λ=λ₀×λ is satisfied. For example, in a case where the interval P between the heating wires 26 is 2.7 [mm], λ≥67.5 [mm], and a radio wave having a frequency of 4.44 [GHz] or more can be efficiently reflected by the heating wires 26. Note that, in the above description, the heating wire 26 disposed at the predetermined interval P [mm] and having a width narrower than the interval P has been exemplified, but the conductive wire including the heating wire 26 does not necessarily have electric heating properties, and a parasitic conductive wire to which no voltage is applied may be disposed.

In addition, the conductive member 100 may be a transparent or translucent planar conductive film disposed on the inner layer or the main surface 22 of the glass plate 1, a heat generating wire disposed on the inner layer or the surface of the glass plate 1, or a silver-based print formed on the surface of the glass plate 1. In a case where the conductive member 100 is installed on the inner layer of the glass plate 1, the conductive member 100 is sealed in the laminated glass (glass plate 1).

The conductive member 100 is, for example, a planar conductor disposed on the inner layer or the main surface 22 side of the glass plate 1. The conductive member 100 may be a conductor that is in contact with the main surface 22 or a conductor that sandwiches the indirect member with the main surface 22. Specific examples of the conductive member 100 include a metal film such as an Ag (silver) film, a metal oxide film such as an indium tin oxide (ITO) film, a resin film containing conductive fine particles, and a laminate in which a plurality of types of films are laminated. The conductive member 100 may be formed by coating a resin film such as polyethylene terephthalate by vapor deposition or the like. The conductive member 100 may be formed in a mesh shape on a film by conductive ink or etching.

The conductive member 100 may be a conductive film coated on the main surface 22 of the glass plate 1. Specific examples of the conductive film include a low-radiation film such as a low emissivity (low-E) film exhibiting low radiation performance.

The low radiation means to reduce heat transfer due to radiation. A low-radiation film such as a low-E film suppresses heat transfer due to radiation, thereby securing heat insulating properties. The low-radiation film may be a general film, and may be, for example, a laminated film including a transparent dielectric film, an infrared reflecting film, and a transparent dielectric film in this order. The transparent dielectric material film is typically a metal oxide or a metal nitride. As the metal oxide, zinc oxide and tin oxide are representative. The infrared reflecting film is typically a metal film. The metal film is typically silver (Ag). Here, one or more infrared reflecting films may be formed between the transparent dielectric material films.

In addition, the conductive member 100 is not limited to a low-radiation film such as a low-E film, and may have other functions as long as it is a conductive layer. For example, the conductive member 100 may have functions such as anti-icing and anti-fogging of the window glass by heat generation due to voltage application.

Further, the conductive member 100 may be a conductive film included in a light control film capable of actively changing the visible light transmittance of the glass plate 1 by applying an AC voltage. The light control film has, for example, a molecular layer (not illustrated) having optical anisotropy between a pair of facing resin substrates (not illustrated). A conductive film (not illustrated) and an electrode (not illustrated) electrically connected to the conductive film are provided on the main surface of each resin substrate. Then, the light control film is driven by applying a voltage between the pair of conductive layers via the electrode.

The resin substrate is made of, for example, a transparent resin. The resin substrate may have, for example, polyethylene terephthalate (PET), polycarbonate (PC), or cycloolefin polymer (COP). In addition, for example, the above-described resins may be used in combination as the pair of facing resin substrates. The thickness of the resin substrate is, for example, in the range of 5 μm to 500 μm, preferably in the range of 10 μm to 200 μm, and more preferably in the range of 50 μm to 150 μm.

The conductive film may include, for example, a transparent conductive oxide, a transparent conductive polymer, a laminated film of a metal layer and a dielectric layer, a silver nanowire, a metal mesh of silver or copper, and the like. The thickness of the conductive film may be, for example, in a range of 200 nm to 2 μm.

Examples of the molecule having optical anisotropy include liquid crystals. That is, for example, a liquid crystal layer may be used as the molecular layer having optical anisotropy. Examples of the liquid crystal layer include polymer dispersed liquid crystal (PDLC), polymer network liquid crystal (PNLC), and guest-host liquid crystal. Alternatively, iodine or the like may be used as the molecule having optical anisotropy. The light control film may have a suspended particle device (SPD) including such a molecular layer.

In this example, the length of the antenna 30 in the direction along the outer edge (in this example, the upper edge 1a) of the glass plate 1 is longer than the length in the direction orthogonal to the direction along the outer edge. In this case, when the above-described line 33 (FIGS. 8 and 9) extending from the antenna toward the outer edge is used, signal feeding to the antenna 30 becomes easy.

Although not particularly illustrated, the length of the antenna 30 in the direction along the outer edge of the glass plate 1 may be shorter than the length in the direction orthogonal to the direction along the outer edge. In this case, since the antenna 30 is easily brought close to the outer edge, the signal feeding to the antenna 30 is facilitated by the feeding structure of FIG. 7 described above.

The window glass for a vehicle 301 may include a light shielding layer 7 that shields visible light. The light shielding layer 7 is provided along the outer edge of the glass plate 1. When the antenna 30 overlaps at least a part of the light shielding layer 7 in a plan view of the glass plate 1, a portion overlapping the light shielding layer 7 is hardly visually recognized, so that the appearance of the window glass for a vehicle 301 is improved.

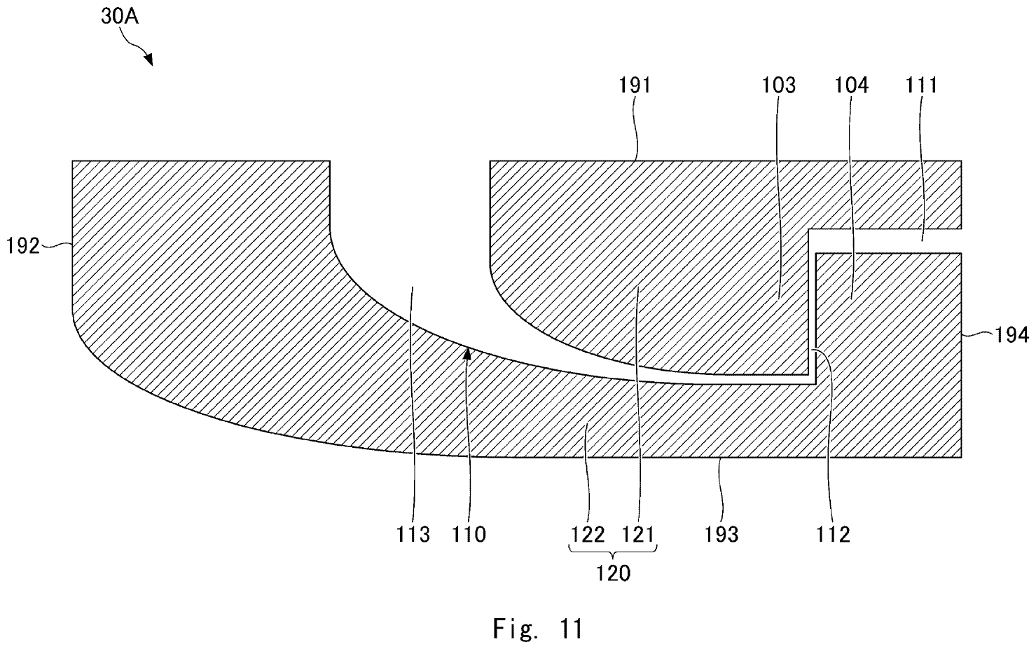

FIG. 11 is a plan view illustrating a specific example of the planar antenna according to the present embodiment. An antenna 30A is an example of the antenna 30. The antenna 30 includes a flat antenna element pattern 120 in which a slot 110 is formed. The slot 110 is an elongated notch formed in the antenna element pattern 120.

The antenna element pattern 120 is an example of a film-like or plate-like flat conductor, and in this example, is a conductive film (film having conductivity) whose outer shape is formed in a substantially rectangular shape as a whole. The antenna element pattern 120 has an outer edge 191 on the first direction side, an outer edge 192 on the second direction side, an outer edge 193 on the third direction side, and an outer edge 194 on the fourth direction side.

The antenna element pattern 120 includes a flat first antenna element pattern 121 extending to one side with respect to the slot 110 and a flat second antenna element pattern 122 extending to the other side with respect to the slot 110. In the present embodiment, first antenna element pattern 121 and second antenna element pattern 122 are separated by the slot 110.

The first antenna element pattern 121 has a feeding area 103 to which a signal line (not illustrated) is electrically connected, and the second antenna element pattern 122 has a ground area 104 to which a ground line (not illustrated) is electrically connected. The feeding area 103 and the ground area 104 form a feeding portion of the antenna 30A.

The slot 110 includes a slot 111, a slot 112, and a slot 113. The slot 111, the slot 112, and the slot 113 are continuously connected in this connection order.

The slot 111 extends in a direction from the outer edge 194 toward the outer edge 192. The slot 112 extends from an end in an extending direction of the slot 111 in a direction from the outer edge 191 toward the outer edge 193. The slot 113 extends in a J shape from the end in the extending direction of the slot 112 to the outer edge 191 and opens at the outer edge 191. The slot width at the open end of the slot 113 is wider than the slot width at the end in the extending direction of the slot 112.

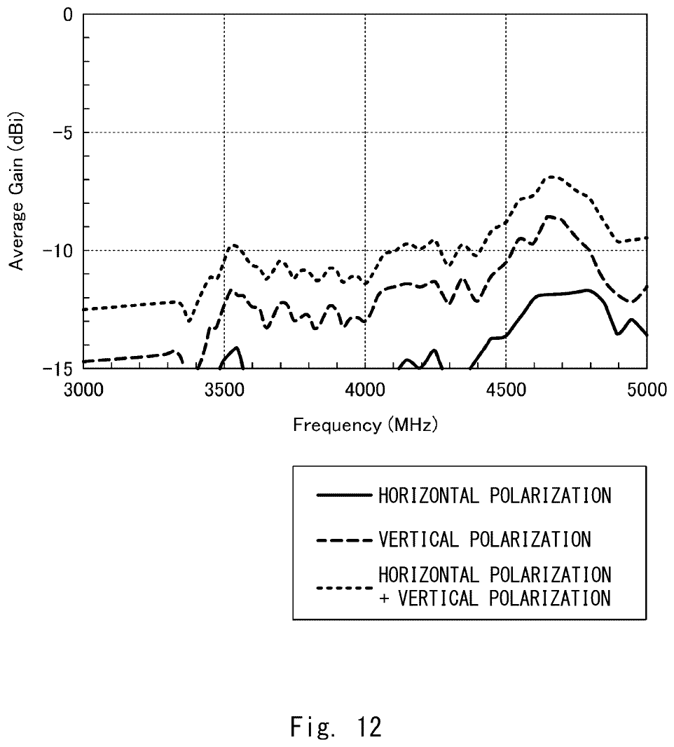

FIG. 12 is a diagram illustrating an example of a measurement result of the frequency characteristics of the antenna 30A illustrated in FIG. 11. FIG. 12 illustrates a measurement result of the antenna gain on the horizontal plane of the antenna 30A in a state where the window glass for a vehicle in which the conductive member 100 is interposed between the glass plate and the antenna 30A is attached to the vehicle.

In a case where the conductive member 100 is interposed, according to FIG. 12, in a low frequency band of less than 3.3 GHZ, the antenna gain decreases due to the influence of the capacitance existing between the antenna 30A and the conductive member 100. On the other hand, in a high frequency band of 3.3 GHZ or more, a decrease in the antenna gain is suppressed, and a sufficient antenna gain functioning as an antenna is secured.

As described above, the embodiment has been described, but the above embodiment is presented as an example, and the present invention is not limited by the above embodiment. The above-described embodiments can be implemented in various other forms, and various combinations, omissions, substitutions, changes, and the like can be made without departing from the gist of the invention. These embodiments and modifications thereof are included in the scope and gist of the invention, and are included in the invention described in the claims and the equivalent scope thereof.

The present international application claims priority based on Japanese Patent Application No. 2022-186874 filed on Nov. 22, 2022, and the entire contents of Japanese Patent Application No. 2022-186874 are incorporated herein by reference.

With regard to the above embodiments, the following supplementary notes are further disclosed.

### Supplementary Note 1

A window glass for a vehicle including
a laminated glass for a vehicle including a first glass plate having a first main surface and a second main surface opposite to the first main surface, a second glass plate having a third main surface facing the second main surface and a fourth main surface opposite to the third main surface, and an interlayer film disposed between the second main surface and the third main surface,
a planar antenna disposed between the second main surface and the third main surface, and
a conductive member that is separated from the antenna in a direction from the first glass plate toward the second glass plate and overlaps at least a part of the antenna in a plan view of the laminated glass.

### Supplementary Note 2

The window glass for a vehicle according to Supplementary Note 1, in which the antenna is disposed between the second main surface and the interlayer film.

### Supplementary Note 3

The window glass for a vehicle according to Supplementary Note 1 or 2, in which the conductive member is disposed between the interlayer film and the third main surface.

### Supplementary Note 4

The window glass for a vehicle according to Supplementary Note 1 or 2, in which the interlayer film includes a first interlayer film and a second interlayer film sandwiching the conductive member in a thickness direction of the laminated glass.

### Supplementary Note 5

The window glass for a vehicle according to Supplementary Note 1 or 3, in which the interlayer film includes a first interlayer film and a second interlayer film sandwiching the antenna in a thickness direction of the laminated glass.

### Supplementary Note 6

The window glass for a vehicle according to Supplementary Note 5, in which
the second interlayer film is disposed between the first interlayer film and the third main surface, and
the conductive member is disposed between the second interlayer film and the third main surface.

### Supplementary Note 7

The window glass for a vehicle according to any one of Supplementary Notes 1, 2, and 5, in which the conductive member is disposed on the fourth main surface.

### Supplementary Note 8

The window glass for a vehicle according to any one of Supplementary Notes 1 to 7, in which the conductive member includes a conductive wire disposed at a predetermined interval and having a width narrower than the interval.

### Supplementary Note 9

The window glass for a vehicle according to Supplementary Note 8, in which when a wavelength of a radio wave transmitted and received by the antenna with respect to a frequency F is λ, the interval is λ/25 or less.

### Supplementary Note 10

The window glass for a vehicle according to any one of Supplementary Notes 1 to 9, in which the conductive member includes a planar conductive film.

### Supplementary Note 11

The window glass for a vehicle according to Supplementary Note 10, in which the conductive film has a sheet resistance of 5 [Ω/□] or more.

### Supplementary Note 12

The window glass for a vehicle according to Supplementary Note 10 or 11, in which the conductive film is a conductive film or a low-radiation film included in a light control film.

### Supplementary Note 13

The window glass for a vehicle according to any one of Supplementary Notes 1 to 12, in which the conductive member includes a first bus bar, a second bus bar separated from the first bus bar, and a heating element connected between the first bus bar and the second bus bar.

### Supplementary Note 14

The window glass for a vehicle according to Supplementary Note 13, in which
the first bus bar includes an upper portion extending in a direction along an upper edge of the laminated glass,
the second bus bar includes a lower portion extending in a direction along a lower edge of the laminated glass, and
the heating element includes a plurality of heating wires connected between the upper portion and the lower portion.

### Supplementary Note 15

The window glass for a vehicle according to any one of Supplementary Notes 1 to 14, further including an electrode provided on the fourth main surface and electrically connected to the antenna.

### Supplementary Note 16

The window glass for a vehicle according to Supplementary Note 15, in which when, in a plan view of the laminated glass, a region in which the conductive member is disposed is defined as a first region, and a region positioned outside the first region is defined as a second region, the electrode is positioned in the second region and faces the antenna or a line connected to the antenna on the same layer with the second glass plate interposed therebetween.

### Supplementary Note 17

The window glass for a vehicle according to Supplementary Note 15 or 16, in which the electrode is connected to the antenna via a line passing through an outside of an end surface of the second glass plate.

### Supplementary Note 18

The window glass for a vehicle according to any one of Supplementary Notes 1 to 17, in which in the antenna, a length in a direction along an outer edge of the laminated glass is longer than a length in a direction orthogonal to the direction along the outer edge.

### Supplementary Note 19

The window glass for a vehicle according to any one of Supplementary Notes 1 to 18, further including a light shielding layer that is provided along the outer edge of the laminated glass and shields visible light,
in which the antenna overlaps at least a part of the light shielding layer in a plan view of the laminated glass.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A window glass for a vehicle comprising:
a laminated glass for a vehicle including a first glass plate having a first main surface and a second main surface opposite to the first main surface, a second glass plate having a third main surface facing the second main surface and a fourth main surface opposite to the third main surface, and an interlayer film disposed between the second main surface and the third main surface;
a planar antenna disposed between the second main surface and the third main surface; and
a conductive member that is separated from the antenna in a direction from the first glass plate toward the second glass plate and overlaps at least a part of the antenna in a plan view of the laminated glass.

2. The window glass for a vehicle according to claim 1, wherein the antenna is disposed between the second main surface and the interlayer film.

3. The window glass for a vehicle according to claim 2, wherein the conductive member is disposed between the interlayer film and the third main surface.

4. The window glass for a vehicle according to claim 2, wherein the interlayer film includes a first interlayer film and a second interlayer film sandwiching the conductive member in a thickness direction of the laminated glass.

5. The window glass for a vehicle according to claim 1, wherein the interlayer film includes a first interlayer film and a second interlayer film sandwiching the antenna in a thickness direction of the laminated glass.

6. The window glass for a vehicle according to claim 5, wherein
the second interlayer film is disposed between the first interlayer film and the third main surface, and
the conductive member is disposed between the second interlayer film and the third main surface.

7. The window glass for a vehicle according to claim 1, wherein the conductive member is disposed on the fourth main surface.

8. The window glass for a vehicle according to claim 1, wherein the conductive member is a conductive wire disposed at a predetermined interval and having a width narrower than the interval.

9. The window glass for a vehicle according to claim 8, wherein when a wavelength of a radio wave transmitted and received by the antenna with respect to a frequency F is λ, the interval is λ/25 or less.

10. The window glass for a vehicle according to claim 1, wherein the conductive member is a planar conductive film.

11. The window glass for a vehicle according to claim 10, wherein the conductive film has a sheet resistance of 5 [Ω/□] or more.

12. The window glass for a vehicle according to claim 11, wherein the conductive film is a conductive film or a low-radiation film included in a light control film.

13. The window glass for a vehicle according to claim 1, wherein the conductive member includes a first bus bar, a second bus bar separated from the first bus bar, and a heating element connected between the first bus bar and the second bus bar.

14. The window glass for a vehicle according to claim 13, wherein
the first bus bar includes an upper portion extending in a direction along an upper edge of the laminated glass,
the second bus bar includes a lower portion extending in a direction along a lower edge of the laminated glass, and
the heating element includes a plurality of heating wires connected between the upper portion and the lower portion.

15. The window glass for a vehicle according to claim 1, further comprising an electrode provided on the fourth main surface and electrically connected to the antenna.

16. The window glass for a vehicle according to claim 15, wherein when, in a plan view of the laminated glass, a region in which the conductive member is disposed is defined as a first region, and a region positioned outside the first region is defined as a second region, the electrode is positioned in the second region and faces the antenna or a line connected to the antenna on the same layer with the second glass plate interposed therebetween.

17. The window glass for a vehicle according to claim 15, wherein the electrode is connected to the antenna via a line passing through an outside of an end surface of the second glass plate.

18. The window glass for a vehicle according to claim 1, wherein in the antenna, a length in a direction along an outer edge of the laminated glass is longer than a length in a direction orthogonal to the direction along the outer edge.

19. The window glass for a vehicle according to claim 18, further comprising a light shielding layer that is provided along the outer edge of the laminated glass and shields visible light,
wherein the antenna overlaps at least a part of the light shielding layer in a plan view of the laminated glass.
